(19) United States
(12) Patent Application Publication
(10) Pub. No.: US 2010/0316116 A1
(43) Pub. Date: Dec. 16, 2010

(54) PROCESSING DATA STREAMS

(76) Inventor: John Iler, Burlington, MA (US)

Correspondence Address: MCANDREWS HELD & MALLOY, LTD, 500 WEST MADISON STREET, SUITE 3400, CHICAGO, IL, 60661, US

(21) Appl. No.: 12/774,888

(22) Filed: May 6, 2010

Related U.S. Application Data
(63) Continuation of application No. 10/730,405, filed on Dec. 8, 2003, now Pat. No. 7,738,552.

(51) Int. Cl. H04N 7/26; H04B 1/66

(52) U.S. Cl. 375/240.01; 375/240; 375/E07.2

(57) ABSTRACT

Streams of data are processed. A stream of data including a plurality of encoded symbols is received. Symbols from a first subset of the encoded symbols are processed contemporaneously to determine a second subset of encoded symbols, each of which uses a common coding context. At least one symbol from the second subset is evaluated to determine the common coding context. The common coding context is used to process the second subset of encoded symbols.

### CROSS REFERENCE TO RELATED APPLICATIONS

The present application claims the benefit of and priority to U.S. provisional application Ser. No. 60/431,407, filed Dec. 6, 2002, entitled “Arithmetic Coding and Bandwidth Enhancement for Digital Video Disc Applications,” the entire disclosure of which is herein incorporated by reference.

### TECHNICAL FIELD

The invention relates to processing data streams In particular, one embodiment of the invention relates to decoding multiple encoded symbols from a stream of video data in one clock cycle.

### BACKGROUND OF THE INVENTION

Arithmetic coding is an entropy coding scheme that addresses certain shortcomings of other current encoding methods, such as Huffman coding. For example, current methods require an integral number of bits for each element of data to be encoded. However, elements with nonintegral entropy require a nonintegral number of bits in the code stream to achieve optimal compression. In addition, the probabilities for each element to be encoded can vary based on a coding context (e.g., the contents of neighboring elements or recently processed elements). One method of addressing the varying probabilities employs a coding table for each context to properly model the conditional probability. However, as the number of contexts rises, the inefficiencies also increase.

Furthermore, the probabilities for each element may vary significantly over time and thus require adaptive, dynamic modifications, which can be expensive in term's of time and/or hardware resources. However, while providing improved results on matching the entropy of the input stream and addressing the issued outlined above, arithmetic coding introduces other implementation difficulties.

Most straightforward implementations of arithmetic coding (particularly those implemented in hardware) require that all of the elements to be coded be binary elements. This generally requires that the potentially multi-bit symbol be ‘binarized’ to a stream of binary digits (bits) (or ‘bins’ in the parlance of the H.264 standard). Furthermore, most hardware implementations code only one bit per clock cycle, and in some cases fewer when multi-bit re-normalization is required.

For some coding standards, the worst case (highest) number of bits being supplied to an arithmetic encoder or out of a corresponding arithmetic decoder can be quite large. For example, an apparatus using the H.264 standard for processing video data and running at a clock rate of 200 MHz, may be required to process 10-20 bits per clock cycle to keep up with real time requirements in the worst case. However, typical implementations handle, at best, one bit per clock cycle.

### BRIEF SUMMARY OF THE INVENTION

In general, the invention relates to processing data streams. Aspects of the invention related to methods of encoding and decoding streams of video data in a manner that can support increased output requirements.

In at least one aspect, the invention relates to a method of processing a stream of data. The method includes receiving a stream of data that includes a plurality of encoded symbols, contemporaneously processing a first subset of the encoded symbols to identify a second subset of the encoded symbols such that each symbol in the subset uses a common coding context, evaluating at least one symbol from the second subset to determine the common coding context, and using the common coding context to process the second subset of encoded symbols.

In at least some embodiments, the processing of the second subset of symbols includes decoding the encoded data stream, which in some embodiments includes encoded video data. The encoded symbols can represent elements of the encoded video data, and can be encoded in a manner consistent with the R264 standard encoding scheme, or in some embodiments with the MPEG-4 part 10 standard encoding scheme.

In another aspect, the invention relates to a method of processing a stream of data. The method includes receiving a stream of data that includes a plurality of symbols to be processed, contemporaneously processing a first subset of the symbols to identify a second subset of the symbols, where each symbol in the second subset uses a common coding context, evaluating at least one symbol from the second subset to determine the common context, and using the common coding context to process the second subset of symbols.

In at least some embodiments, the processing of the second subset includes encoding the stream of data, which in some embodiments includes video data. The symbols can represent elements of the video data, and can be encoded in a manner consistent with the H.264 standard encoding scheme, or in some embodiments with the MPEG-4 part 10 standard encoding scheme.

While particularly useful in the field of video data, these methods are not limited to that specific application, and can be used in similar applications where data streams are encoded or decoded.

### BRIEF DESCRIPTION OF SEVERAL VIEWS OF THE DRAWINGS

In the drawings, like reference characters generally refer to the same elements throughout the different views. In addition, the drawings are not necessarily to scale, emphasis instead generally being placed upon illustrating the principles of the invention.

FIG. 1 illustrates determining the symbol to be used to decode one symbol.

FIG. 2 illustrates a stream of encoded video data.

FIG. 3 illustrates determining the symbol to be used to contemporaneously encode a string of symbols in accordance with the invention.

### DETAILED DESCRIPTION OF THE INVENTION

Implementations of this invention meet the worst case real time coding requirements presented by the real time nature of video. As noted above, typical implementations may handle, at best, one bit per clock cycle. In accordance with the invention, multi-bit coding per cycle techniques are applied to process video data using H.264 and similar standards for encoding and decoding video data. The term H.264 represents the ITU standard H.264, which is similar to the MPEG-4 part 10 standard (also known as the Advanced Video Coding standard) from the International Standards Organization. The H.264 standard represents one possible coding scheme to which this invention can be applied, however any video coding scheme where the acceleration of the coding process is desired can benefit from the techniques described below. One embodiment of the invention is applicable to hardware applications, but it could also be applied to software applications.

Implementations of the invention take advantage of three characteristics of the data streams being processed. Standards such as H.264 define a maximum code stream data rate, and therefore the number of elements with poor compression rates (i.e., the probabilities of each potential symbol are near ¼) are limited. Further, the coding context used to determine the conditional probability for the bit to be coded is often the same for many bits of data in a row, thus allowing the context of one element to be used for the coding of multiple subsequent elements. Third, the long runs of identical coding contexts are often associated with long runs of a most probable symbol (“MPS”).

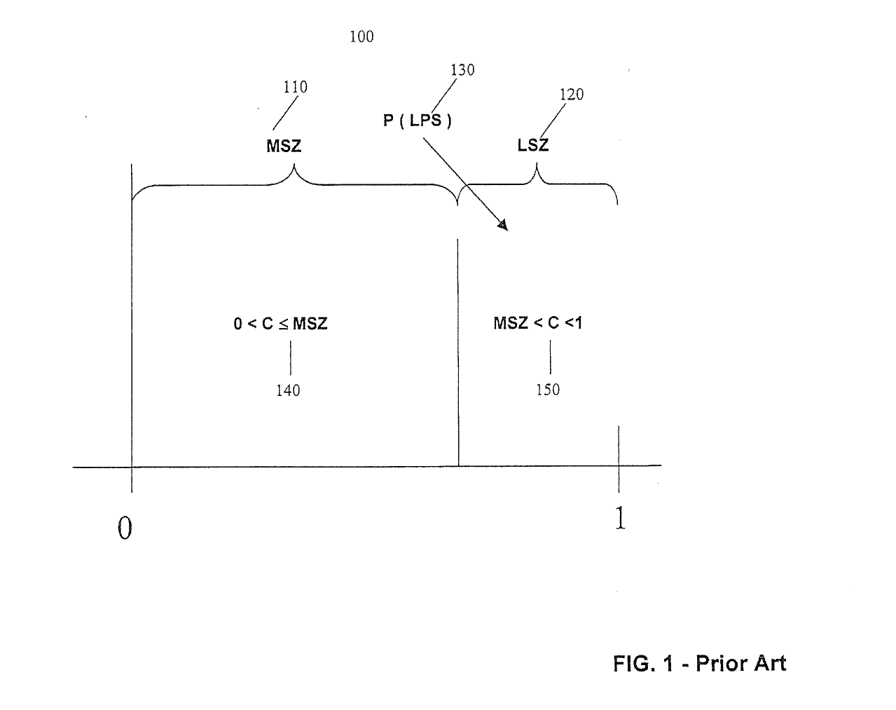

Referring to FIG. 1, a symbol representing an element of a video data stream is to be decoded. Based on previously encoded symbols, a most probable symbol (“MPS”) and a less probable symbol (“LPS”) are identified as potential symbols to be used as a basis in the decoding process. Each symbol has a probability associated with it, based at least in part on the previously decoded symbols and the context models used to decode them. By definition, the MPS has a higher probability of being the appropriate symbol to represent the current symbol than the LPS. By normalizing the probabilities of each symbol, the MPS and LPS can be represented using subintervals of an interval between 0 and 1(100). During each cycle of the decoding process, the decoder maintains values that correspond to the base of the interval and the interval size. The interval is subdivided into two subintervals, which are proportional in size to the relative probabilities of the MPS and the LPS. The MPS subinterval can be considered to be below (or before) the LPS subinterval, and is identified as MSZ (110). The LPS subinterval then includes the remainder of the interval, and is identified as LSZ (120). As a result, the boundary between the MSZ (110) and LSZ (120) is the normalized probability (130) that the MPS is the appropriate symbol to be used for decoding the current symbol.

As the code stream is received by the decoder, a code value is calculated and compared to the boundary line between the MPS and LPS subintervals (130). If the calculated value falls within the MSZ (110), the MPS is used to represent the current symbol. Alternatively, if the code value falls within the LSZ (120), the LPS is used to represent the current symbol. The interval is then updated based on the decoded symbol, using the MSZ interval if the MPS was used, LSZ interval if the LPS was used, and the process is repeated until the code stream is exhausted and all symbols are decoded. The context dependent information is then stored in an associated memory, and the code and interval registers are re-normalized in order to ensure precision is maintained.

Re-normalization is typically done when the interval size drops below i/2. In this case, the code and interval registers are both multiplied by 2 repeatedly until the MSZ is once again in the ½ to 1 range.

The pseudo code below describes one possible representation of this process:

```
/* Definitions */
I = interval
C = Code register
LPS = less probable symbol
MPS = more probable symbol
LSZ = LPS sub interval of I
MSZ = MPS sub interval of I
      /* begin process */
      Initialize decoder
      While encoded symbols exist in stream
            Calculate LSZ based on conditional probabilities of LPS
            Set MSZ = I − LSZ
            If C < MSZ
                  Decoded symbol is MPS
                  Set I = MSZ
            Else
                  Decoded symbol is LPS
                  Set I = LSZ
            End If
                  If I < 0.5
                  Renormalize I and C
            End if
      End while
      /* end process */
```

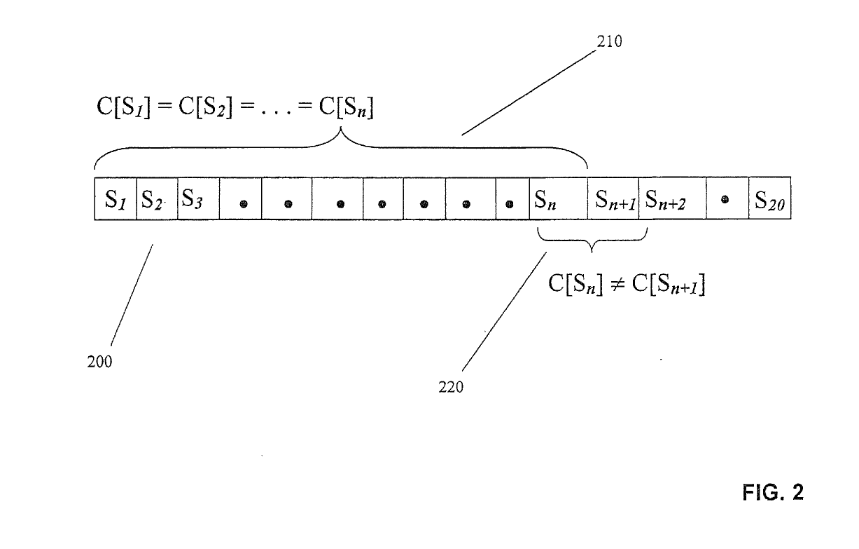

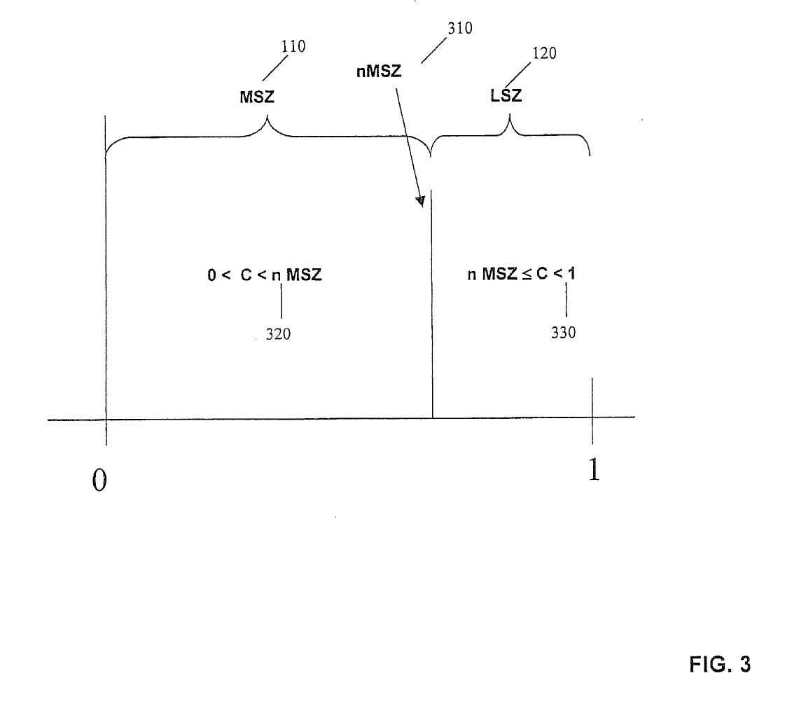

FIGS. 2 and 3 illustrate one possible embodiment of the invention in which multiple symbols are decoded in parallel during one clock cycle of a decoding device such as an H.264 codec. Referring to FIG. 2, in one embodiment, the maximum number of symbols per cycle that need to be encoded to support the input requirements of the playback device may be 20 symbols per coding cycle. In such a case, a string of up to 20 encoded symbols 200 (denoted as S₁, S₂, . . . S₂₀) that are to be decoded are fed into a decoder device, which determines the context (C) for a series of symbols 210 (denoted as S₁, S₂, . . . Sₙ which are a subset of the string 200. Initially, the subset of symbols includes the entire string of 20 symbols (i.e., n N=20). If the context for each of the 20 symbols is not equal, n is reduced by one and the decoder determines if the contexts for the remaining 19 symbols are equal. This process continues until the series of symbols 210 is comprised of a set of n symbols where n<20, each having the same coding context. By definition, the context of the next symbol in the string, So−1 is either • different from the context of the previous symbol if n<20 as shown by the comparison 220, or the next symbol is not needed based on the maximum required output (i.e., it is the 21st symbol). In other embodiments, other values for N can be used as the maximum output rate.

Once the series of symbols 210 having the same context is determined, the decoder determines if the symbols to be decoded are properly represented by a series of MPSs. The decoder determines the LSZ value for the current context based on the LPS for the series of symbols 210, and multiples the value by n, the number of symbols in the series 210 to obtain a boundary value 310 equal to I−(n*LSZ). If the code register value C1 320 10 falls below the boundary 310, then there is a string of MPSs that can all be output in the same cycle. In some embodiments, the decoder attempts to identify, in parallel, multiple values for N for which C1 falls below the boundary 310. Once the decoder has determined the maximum value for N meeting the above criteria (max(N)), it produces a string of MP Ss of length max(N).

The pseudo code below describes one possible representation of this process:

```
/* Definitions */
I = interval
C = Code register as determined from the coding contexts
LPS = less probable symbol MPS = more probable symbol
LSZ = LPS sub interval of I MSZ = MPS sub interval of I
N = Upper bound on number of symbols to encode
n = number of symbols in current series
      /* begin process */
      Initialize decoder
      While encoded symbols exist in stream
            For all choices of n from highest to lowest
                  If coding context is the same for the next n
                  symbols
                        nMSZ = I − ( n * LSZ)
                  if (nMSZ >−= 0.5)
                        if C < nMSZ
                              output n MPSs
                              I = nMSZ
                              Renormalize I and C
                              goto next ‘while’ loop iteration
                        end if
                  end if
            end if
      end
      /* decode single symbol in usual (nonaccelerated) fashion
      */
      if C < MSZ
            decoded symbol is MPS
            Set I = MSZ
      Else
            Decoded symbol is LPS
            Set I = LSZ
      End if
      If 1< 0.5
            Renormalize I and C
      End if
End while
/* end process */
```

In some embodiments, the contexts for multiple symbols can be determined in parallel using separate hardware means. As the value of N increases, the encoding or decoding speed will increase and additional hardware is required to process the symbols_{—} In other embodiments the step of determining the contexts can be implemented using software means.

The method used to determine the context of each symbol can differ depending on the coding standard being used by the encoder device. For example, in some embodiments the contexts are calculated from previously encoded (or decoded) symbols.

The various methods of calculating contexts differ from coding standard to coding standard, and are well known throughout the industry.

By applying processing multiple symbols in parallel, many possible cases can be optimized for single cycle operation. As an illustration, when four comparisons are done in parallel, the invention allows the coding of 1, 2, 4, and 8 MPS runs each in a single cycle. In the case of H.264, it is desirable to have, for example, as many as 20 parallel comparisons to provide maximum decoding acceleration. In some embodiments, the encoder checks if the interval needs to be re-normalized during each cycle.

The discussions above describes applying a multi-bit technique when decoding. Similar concepts may be used when encoding a stream of video data. In one possible embodiment, a decoder looks ahead N bits (where N is the desired maximum run of MPSs to code simultaneously) to determine if each bit can all be represented by the MPS. Similar to the decoding example above, the encoder can simultaneously check for any number of MPS run lengths in parallel. Once the maximum length MPS run that does not require re-normalization is determined, then all of the MPS bits can be encoded in a single cycle. Many standard techniques can be applied in hardware to reduce logic and/or increase speed for determining the maximum length MPS run.

The methods described above may be implemented using one or more data processing devices. In some embodiments, the data processing devices may implement the functionality of the present invention in hardware, using, for example, a computer chip. The data processing device may receive signals in analog or digital form. In other embodiments, the data processing device may implement the functionality of the present invention as software on a general purpose computer, video display device, or other electronic device. In such an embodiment, the program may be written in any one of a number of programming languages, such as FORTRAN, PASCAL, C; C++, C#, Tel, or BASIC. Further, the program can be written in a script, macro, or functionality embedded in commercially available software, such as EXCEL or VISUAL BASIC.

Additionally, the software could be implemented in an assembly language directed to a microprocessor resident on a video display device, computer or other electronic device. For example, the software can be implemented in Intel 80×86 assembly language if it is configured to run on an IBM PC or PC clone. The software may be embedded on an article of manufacture including, but not limited to, “machine-readable program means” such as a floppy disk, a hard disk, an optical disk, a magnetic tape, a PROM, an EPROM, ROM, or CD-ROM.

Variations, modifications, and other implementations of what is described herein will occur to those of ordinary skill in the art without departing from the spirit and the scope of the invention as claimed. Accordingly, the invention is to be defined not by the preceding illustrative description but instead by the spirit and scope of the following claims.

What is claimed is:

1. A method of processing a stream of data, comprising:
receiving a stream of data, the stream of data including a plurality of encoded symbols;
contemporaneously processing a first subset of the encoded symbols to identify a second subset of the encoded symbols, where each encoded symbol in the second subset uses a common coding context;
evaluating at least one symbol from the second subset of encoded symbols to determine the common coding context for the second subset; and
using the common coding context to process the second subset of encoded symbols.

2. The method of claim 1 wherein processing the second subset of encoded symbols comprises decoding the stream of data.

3. The method of claim 1 wherein the data stream includes encoded video data.

4. The method of claim 3 wherein the encoded symbols represent elements of the encoded video data.

5. The method of claim 4 wherein the encoded symbols are encoded using the H.264 standard encoding scheme.

6. The method of claim 4 wherein the encoded symbols are encoded using the MPEG-4 part 10 standard encoding scheme.

7. A method of processing a stream of data, comprising:
receiving a stream of data, the stream of data comprising a plurality of symbols to be processed;
contemporaneously processing a first subset of the symbols to identify a second subset of the symbols, where each symbol in the second subset uses a common coding context;
evaluating at least one symbol from the second subset of symbols to determine the common coding context; and
using the common coding context to process the second subset of symbols.

8. The method of claim 7 wherein the processing of the second subset of symbols includes encoding the stream of data.

9. The method of claim 7 wherein the stream of data includes video data.

10. The method of claim 9 wherein the symbols represent elements of the video data.

11. The method of claim 10 wherein the video data is encoded using the H.264 standard encoding scheme.

12. The method of claim 10 wherein the video data is encoded using the MPEG-4 part 10 standard encoding scheme.
